(19) United States
(12) Patent Application Publication
(10) Pub. No.: US 2021/0403220 A1
(43) Pub. Date: Dec. 30, 2021

(54) METHOD FOR MANUFACTURING PACKAGED FROZEN FOOD PRODUCT, FOOD PACKAGING FILM, AND PACKAGED FROZEN FOOD PRODUCT

(71) Applicant: Yuabread, Inc., Gunma (JP)

(72) Inventor: Kenta Yano, Gunma (JP)

(21) Appl. No.: 17/459,716

(22) Filed: Aug. 27, 2021

Related U.S. Application Data
(63) Continuation-in-part of application No. PCT/JP2020/005295, filed on Feb. 12, 2020.

(30) Foreign Application Priority Data
Mar. 1, 2019 (JP) 2019-037308

(51) Int. Cl. B65D 81/20; A21D 15/02; A21D 15/08; A23B 9/10; A23B 9/14

(52) U.S. Cl. CPC B65D 81/2084; A21D 15/02; A23B 9/14; A23B 9/10; A21D 15/08

(57) ABSTRACT

The purpose of the present invention is to provide a method of manufacturing a packaged frozen food product as well as a food packaging film and a packaged frozen food product, in which savor of freshly made food can be experienced when opening the package after thawing the frozen food. This method of manufacturing a packaged frozen food product comprises a packaging step of hermetically packaging food in a film including a gas barrier layer after baking or steaming the food and before temperature of the food drops to room temperature, the food being unbaked confectionery, semi-baked confectionery, bread, or rice cake; and a freezing step of freezing the food packaged in the packaging step, and obtaining frozen food.

### RELATED APPLICATIONS

This application is a Continuation-in-Part of International Patent Application No. PCT/JP2020/005295, filed on Feb. 12, 2020, now International Publication No. WO 2020/179383 A1, published on Sep. 10, 2020, which claims priority to Japanese Application No. 2019-037308, filed Mar. 1, 2019, all of which are incorporated herein by reference in their entirety.

### TECHNICAL FIELD

The present invention relates to a method of manufacturing a packaged frozen food product, as well as a food packaging film and a packaged frozen food product.

### BACKGROUND ART

From a perspective of aroma and taste of freshly baked bread, bread is preferred to be eaten freshly baked. However, bread may be eaten after a certain amount of time has elapsed since the bread was manufactured. For example, in a case in which the place of manufacturing bread is far from the place of selling or eating bread, or the bread cannot be eaten at one time, the manufactured bread may be frozen to make frozen bread, and the frozen bread may be thawed and eaten after a desired period of storage.

As such a technique to freeze and store bread, techniques have been disclosed whereby manufactured bread is frozen and subsequently packaged and stored (see, for example, Japanese Patent Nos. 3665152 and 6125647).

Patent Document 1: Japanese Patent No. 3665152

Patent Document 2: Japanese Patent No. 6125647

### DISCLOSURE OF THE INVENTION

### Problems to be Solved by the Invention

However, the techniques disclosed in Japanese Patent Nos. 3665152 and 6125647 have a drawback that aroma or taste of freshly baked bread cannot be experienced when opening the package after thawing the frozen bread. As such, the drawback that savor of freshly made food cannot be experienced is not exclusive to bread but common to food such as unbaked confectionery, semi-baked confectionery, or rice cake.

The present invention has been made against the background described above, and an object of the present invention is to provide a method of manufacturing a packaged frozen food product as well as a food packaging film and a packaged frozen food product, in which savor of freshly made food can be experienced when opening the package after thawing the frozen food.

### Means for Solving the Problems

The present inventors have completed the present invention by finding that food is hermetically packaged in a film having a gas barrier layer after baking or steaming manufactured food and before temperature of the food drops to room temperature, and the packaged food is subsequently frozen, then the aroma or taste of freshly baked food can be experienced when opening the package after thawing the frozen food. More specifically, the present invention provides the following.

(1) A method of manufacturing a packaged frozen food product, the method including: a packaging step of hermetically packaging food in a film including a gas barrier layer after baking or steaming the food and before temperature of the food drops to room temperature, the food being unbaked confectionery, semi-baked confectionery, bread, or rice cake; and a freezing step of freezing the food packaged in the packaging step, and obtaining frozen food.

(2) The method of manufacturing a packaged frozen food product as described in (1), in which the method does not include a step of replacing gas in the film after the packaging step.

(3) The method of manufacturing a packaged frozen food product as described in (1) or (2), in which the food is hermetically packaged within two minutes after placing the food in the film in the packaging step.

(4) The method of manufacturing a packaged frozen food product as described in any one of (1) to (3), in which the food is hermetically packaged in a state in which steam released from the food is visually recognizable in the packaging step.

(5) A food packaging film including a gas barrier layer, in which the food packaging film is used for hermetically packaging food after baking or steaming the food and before temperature of the food drops to room temperature, and freezing the food in the food packaging film.

(6) The food packaging film as described in (5), in which water vapor permeability is 20 g/(m²·day) or less, as measured under conditions of 40° C. and 90% RH, based on JIS K 7129.

(7) The food packaging film as described in (5) or (6), in which the gas barrier layer has desired low permeability to aroma components selected from a group consisting of acetaldehyde, hexanal, 2-heptene, 2-nonanone, nonanal, and ethyl octanoate.

(8) The food packaging film as described in any one of (5) to (7), in which the gas barrier layer includes one or more selected from a group consisting of ethylene vinyl alcohol copolymer resin (EvOH), polyvinyl alcohol (PVA), polyacrylonitrile (PAN), and cyclic olefin copolymer (COC).

(9) The food packaging film as described in any one of (5) to (8), further including: a guiding portion that is provided at an outer edge of the film and guides a start of cutting; and a defining portion that is provided on the film and is spaced apart from the guiding portion, the defining portion defining an end position of the cutting.

(10) A packaged frozen food product, including: the food packaging film as described in any one of (5) to (9); and frozen food that is food hermetically packaged in the food packaging film after baking or steaming the food and before temperature of the food drops to room temperature, the food being subsequently frozen, in which the packaged frozen food product is used by opening the food packaging film after thawing the frozen food.

### Effects of the Invention

The present invention can manufacture a packaged frozen food product, in which savor of freshly made food can be experienced when opening the package after thawing the frozen food. Further, the present invention can provide a packaged frozen food product and a food packaging film, which can be used for a method of manufacturing the packaged frozen food product.

### PREFERRED MODE FOR CARRYING OUT THE INVENTION

Hereinafter, embodiments of the present invention will be described in detail. It should be noted that the present invention is not limited to the following embodiments.

### <Method of Manufacturing Packaged Frozen Food Product>

The method of manufacturing a packaged frozen food product of the present invention includes: a packaging step of hermetically packaging food in a film having a gas barrier layer after baking or steaming the food and before temperature of the food drops to room temperature, the food being unbaked confectionery, semi-baked confectionery, bread, or rice cake; and a freezing step of freezing the food packaged in the packaging step, and obtaining frozen food.

Food used for the method of manufacturing a packaged frozen food product of the present invention is not limited in particular, as long as the food is unbaked confectionery, semi-baked confectionery, bread, or rice cake. Among them, bread and unbaked or semi-baked confectionery using bread are preferable, since texture as well as aroma can be improved (in particular, unbaked or semi-baked confectionery having bread exposed outside). As the food used for the method of manufacturing a packaged frozen food product of the present invention, foods other than donuts are preferred.

Unbaked confectionery refers to confectionery (western-style confectionery, Japanese-style confectionery, etc.), in which the outermost side has a water content of 40% or more, or confectionery using adzuki bean paste, cream, jam, agar, etc. and having water content of 30% or more. Semi-baked confectionery refers to confectionery having a water content of 10 to 30%. Examples of confectionery may include western-style confectionery such as sponge cakes, butter cakes, puff confectionery, fermented confectionery, feuilletages, waffles, dessert confectionery, and confectionary cuisines; and Japanese-style confectionery such as rice cake confectionery, steamed confectionery, baked confectionery, jelly confectionery, kneaded confectionery, adzuki bean paste confectionery, and combined confectionery.

Examples of bread may include bread, French bread, bread roll, croissant, etc. In particular, bread such as baguette or pain de campagne releasing strong aroma is preferably used, from a perspective of further achieving the effect of the present invention which can provide a packaged frozen bread product, in which aroma of freshly baked bread can be experienced when opening the package after thawing the frozen bread (i.e., the aroma of freshly baked bread can be stronger).

Rice cake refers to undried (or non-fried) types of rice cake processed from glutinous rice or food like rice cake (such as daifuku) processed from other materials (such as rice cake flour), which may have, for example, water content of 10% or more, without limitation in particular.

In the packaging step, the food is packaged after manufacturing such food, i.e., after baking or steaming the food and before temperature of the food drops to room temperature. In this specification, room temperature is typically 20° C. Here, aroma components such as acetaldehyde, hexanal, 2-heptene, 2-nonanone, nonanal, or ethyl octanoate are released from food such as bread after baking. Water vapor is released as well. These factors contribute to the aroma or taste of food such as freshly baked bread (i.e., food such as bread after baking or steaming and before temperature drops to room temperature). In the case of not reheating the food after baking or steaming, the temperature of the food will drop, the amount of savor (aroma) components and the content of water vapor released from the food will decrease as the temperature drops, and the release of the savor (aroma) components and water vapor from the food will almost cease at room temperature. In this manner, the present invention packages the food before the release of the savor (aroma) components and water vapor ceases, i.e., before the temperature of the food drops to room temperature. Therefore, in the packaging step, food is packaged in a state in which savor (aroma) components and water vapor are being released from the food.

In the packaging step, as described above, the temperature may be higher than room temperature until completion of packaging the food; however, the release of savor (aroma) components and water vapor from the food proceeds while the temperature is dropping to room temperature after baking or steaming; therefore, from a perspective of further achieving the effect of the present invention which can provide a packaged frozen food product, in which savor of freshly made food can be experienced when opening the package after thawing the frozen food, the temperature is preferably not excessively lower than the temperature of baking or steaming until completion of packaging the food, and for example, packaging the food is preferably completed in a state in which steam released from the food is visually recognizable, or packaging the food is preferably completed quickly after the food is cooled to a certain degree, specifically, while the temperature of the food is 25° C. or higher. The upper limit of the temperature of the food is not limited in particular, and may be 90° C. or less, 80° C. or less, 70° C. or less, 60° C. or less, 50° C. or less, or 40° C. or less, from a perspective that, if the temperature is excessively high, an excessive amount of hoarfrost may arise inside the package and the functionality of the food may be affected, depending on the atmospheric conditions (in particular, high temperature or high humidity in summer or the like).

In the packaging step, the food is hermetically packaged in a film having a gas barrier layer (hereinafter also referred to as “food packaging film”).

In this specification, the gas barrier layer is a layer having gas barrier properties that are properties allowing for suppressing permeation of savor (aroma) components such as acetaldehyde, hexanal, 2-heptene, 2-nonanone, nonanal, or ethyl octanoate released from food such as bread, and/or water vapor released from food. The savor (aroma) components are aroma components specific to food such as bread immediately after baking, in which acetaldehyde provides bread dough fermentation odor; hexanal provides aroma of leaves rubbed; 2-heptene provides aroma of charcoal fire; 2-nonanone provides aroma of baked confectionery; nonanal provides aroma specific to crust of bread; and ethyl octanoate provides aroma like bread.

An example of the gas barrier layer may be a layer (film) including one or more selected from the group consisting of ethylene vinyl alcohol copolymer resin (EvOH), polyvinyl alcohol (PVA), polyacrylonitrile (PAN), and cyclic olefin copolymer (COC). Ethylene vinyl alcohol copolymer resin (EvOH) is a resin obtained through hydrolysis of ethylene and vinyl acetate copolymer. A gas barrier layer containing these components is known to have low permeability to aromatic compounds in general, and also has desired low permeability to the aforementioned aroma components such as acetaldehyde.

The food packaging film having a gas barrier layer may have a gas barrier layer that is a layer capable of suppressing permeation of savor (aroma) components released from food and/or water vapor released from food, and for example, may have desired low permeability to savor (aroma) components, in which the water vapor permeability of the food packaging film having a gas barrier layer is preferably 20 g/(m²·day) or less, as measured under the conditions of 40° C. and 90% RH, based on JIS K 7129. The water vapor permeability and the permeability to savor (aroma) components released from freshly made food are correlated, from a perspective of gas permeation. When the water vapor permeability is 20 g/(m²·day) or less, permeation of the savor (aroma) components released from freshly made food is low, so that savor (aroma) components released from the baked or steamed food cannot leak out of the package. The upper limit of the water vapor permeability may preferably be 15 g/(m²·day) or less, or 10 g/(m²·day) or less. The lower limit is not limited in particular, and may be, for example, 0.2 g/(m²·day) or more, specifically 1 g/(m²·day) or more, so that hoarfrost can be appropriately suppressed from arising inside the packaging bag. It should be noted that, in the case of packaging after freezing, water vapor permeability corresponding to a low saturation water vapor pressure at the freezing temperature may suffice; however, in the present invention, sufficiently low water vapor permeability as described above is preferable since temperature of food when packaging is equal to or higher than room temperature.

The food packaging film having a gas barrier layer may be a film composed only of a gas barrier layer, or a film having a multilayer structure in which a gas barrier layer and another layer (e.g., a heat-sealing layer, typically containing polyolefin or the like) are laminated. Specific examples of films available as a food packaging film having a gas barrier layer may include multilayer films disclosed in Japanese Unexamined Patent Application, Publication No. 2018-58364, Japanese Patent Nos. 3227301, 6075515, and 5477114.

By packaging in the packaging film having a gas barrier layer as described above, savor (aroma) components and/or water vapor existing inside the packaging film can be suppressed from leaking out of the packaging film.

Therefore, food is packaged in the food packaging film having a gas barrier layer in a state in which savor (aroma) components and water vapor are being released from the food after baking or steaming and before the temperature of the food drops to room temperature, whereby the food can be hermetically packaged i.e. in a state in which savor (aroma) components and water vapor released from the baked or steamed food inside the package will not leak out of the package (non-leakage permits a very small amount thereof to permeate a film).

From a perspective that the temperature until completion of packaging the food is preferably not excessively lower than the temperature of baking or steaming, and from another perspective that savor (aroma) components and water vapor released from the freshly made food should be confined inside the package as much as possible, the food is preferably hermetically packaged at least within 45 minutes, or within 2 minutes in particular, after placing the food in the food packaging film having a gas barrier layer. The time may preferably be within 90 seconds, 60 seconds, 45 seconds, 30 seconds, or 15 seconds.

After the packaging step, the food packaged in the packaging step is frozen to obtain frozen food (freezing step). A method of freezing food in the freezing step is not limited in particular, and for example, the packaged food as packaged may be placed and frozen in a freezer. The means used for freezing is not limited in particular, and may be an instant freezing machine; or cooling means having a normal or slow cooling rate, such as a household refrigerator/freezer or an industrial freezer installed at stores or the like, may suffice.

As described above, in the present invention, the food is packaged and then frozen in a state in which savor (aroma) components released from the baked or steamed food inside the package will not leak out of the package; therefore, the savor (aroma) components contained in the package are released when opening the package after thawing the frozen food, so that aroma of freshly made food can be experienced, and aroma of freshly made food can be enjoyed. Further, the food is packaged and then frozen in a state in which water vapor released from the baked or steamed food inside the package will not leak out of the package, whereby water content derived from water vapor released from freshly baked food contained in the package will be absorbed by the food while thawing, so that texture of freshly made food can also be enjoyed when opening the package after thawing the frozen food.

Here, in the case in which bread is frozen and then packaged as in Japanese Patent Nos. 3665152 and 6125647, aroma components of freshly baked bread are released from the bread before freezing, and the bread is packaged after freezing the bread; therefore, most of the aroma components of freshly baked bread have already been released. Therefore, a content of savor (aroma) components released from freshly made food will be considerably small, inside the package that packages the food. Accordingly, in the case of freezing and then packaging the food, it is difficult to experience aroma of freshly made food when opening the package after thawing the frozen food. In addition, in the case of freezing and then packaging the food, water vapor of freshly made food is released from the food before freezing, so that the water content of the food and the water content inside the package have been reduced when packaging. Therefore, in the case of freezing and then packaging the food, when opening the package after thawing the frozen food, the amount of water content contained in the food is considerably lower than the amount of water content contained in freshly made food, the food is dry, and taste of freshly made food cannot be experienced. It should be noted that, when the food is frozen, thawed, and then heated at high temperature, although savor (aroma) components may be released from the food, the savor (aroma) components released from the food once frozen (frozen food) may be different from savor (aroma) components released from freshly made food, so that it is difficult to experience aroma of freshly made food when opening.

However, in the present invention, before freezing the baked or steamed food, the food is packaged in a packaging film such that savor (aroma) components and water vapor released from freshly made food will be contained inside the packaging film and then frozen; therefore, aroma and taste of freshly made food can be experienced when opening the package after thawing the frozen food.

It should be noted that the present invention achieves the effect that aroma or taste of freshly made food can be experienced when opening after thawing, because of savor (aroma) components and water vapor released from freshly made food; therefore, for example, it is preferable not to provide a step of replacing gas such as air inside the package with another gas (typically, a stable gas such as nitrogen) after packaging. From a similar perspective, it is preferable not to arrange a moisture absorbent (silica gel or the like) or a savor (aroma) component adsorbent inside the package.

### <Food Packaging Film>

The food packaging film of the present invention is a food packaging film including a gas barrier layer and is used for hermetically packaging food after baking or steaming the food and before temperature of the food drops to room temperature, and freezing the food in the food packaging film. The food packaging film of the present invention is a film that can be used for the method of manufacturing the packaged frozen food product of the present invention described above, and is configured same as the film (food packaging film) described above in the <Method of manufacturing packaged frozen food product>.

By using such a food packaging film, for example, a packaged frozen food product can be manufactured, in which aroma or taste of freshly baked food can be experienced when opening the package after thawing the frozen food.

In one embodiment, the food packaging film preferably includes: a guiding portion that is provided at an outer edge of the film and guides a start of cutting; and a defining portion that is provided on the film and is spaced apart from the guiding portion, the defining portion defining an end position of the cutting. The guiding portion and the defining portion define the opening width (or the size of an opening) of the film while thawing, so that an amount of aroma components and water vapor lost while thawing can be reduced.

The defining portion may have a structure (physical structure or chemical structure) which is less likely to be cut than a portion between the guiding portion and the defining portion, or may be a portion presented (printed, etc.) with information (characters, symbols, etc.) for identifying or suggesting a position to stop cutting before thawing.

A single guiding portion or two or more guiding portions may be provided, and may be provided continuously or discontinuously. Examples of the discontinuous guiding portion may include a notch provided inward from the outer edge. Examples of the continuous guiding portion may include an outer edge, etc. composed of a material having low rupture strength.

A guiding portion for partial opening before thawing (which is typically positioned near the defining portion); and a guiding portion for full opening after thawing (which is not limited in particular, and may be positioned farther than the guiding portion for partial opening, in relation to the defining portion).

### <Packaged Frozen Food Product>

The packaged frozen food product of the present invention includes: a food packaging film of the <Food packaging film> described above; and food as frozen food, which is hermetically packaged in the food packaging film after baking or steaming and before temperature of the food drops to room temperature, the food being subsequently frozen. The packaged frozen food product is used by thawing the frozen food and then opening the food packaging film. The packaged frozen food product of the present invention is configured same as those described in the <Method of manufacturing packaged frozen food product> and the <Food packaging film> described above. A thawing method is not limited in particular, and may be natural thawing or heat thawing.

With such a packaged frozen food product, aroma or taste of freshly made food can be experienced when opening the package after thawing the frozen food. With the packaged frozen food product of the present invention, the food packaging film is opened after thawing the frozen food; therefore, aroma and taste of freshly made food can be experienced when opening the package after thawing the frozen food. In contrast, in the case of opening the packaging film and then thawing the frozen food, savor (aroma) components and water vapor are released when opening, so that it is difficult to experience aroma and taste of freshly made food when thawing thereafter.

### EXAMPLES

Hereinafter, the present invention will be described in more detail by Examples; however, the present invention is not limited to these Examples.

### Example 1

### Bread

After manufacturing baguette by baking, the baguette was hermetically heat-sealed and packaged using a bread packaging film, in a state in which steam arising from the baguette was observable. The package was filled with aroma components and water vapor arising from the baguette. The baguette was hermetically heat-sealed immediately after placing the baguette in the bread packaging film. A commercially available film including a gas barrier layer containing EvOH was used as a bread packaging film (a film having a thickness of 60 μm, in which a layer of nylon (NY) and a layer of EvOH and polyethylene (PE) are adhered with adhesive resin; water vapor permeability is 10 g/(m²·day) as measured on conditions of 40° C. and 90% RH, based on JIS K 7129). Subsequently, the packaged baguette was frozen at −20° C. to obtain a packaged frozen bread product (frozen baguette product). Thereafter, the packaged frozen bread product was kept frozen for 90 days and then naturally thawed at room temperature (20° C.). A sensory evaluation by a panel of five experts was conducted on aroma and taste (texture) of the bread when opening the packaged frozen bread product thawed. Aroma was evaluated on a scale of 1 to 5 as follows, in which aroma immediately after manufacturing baguette by baking was 5; and aroma of baguette at room temperature was 1. Taste was evaluated on a scale of 1 to 5 as follows, in which taste immediately after manufacturing baguette by baking was 5; and taste of baguette at room temperature was 1. Table 1 shows mean values of the evaluation by the panel of five experts.

“Aroma”
1: Aroma of freshly baked bread is absent
2: Aroma of freshly baked bread exists
3: Aroma of freshly baked bread is slightly strong
4: Aroma of freshly baked bread is strong
5: Aroma of freshly baked bread is very strong

“Taste (Texture)”
1: Taste of freshly baked bread is absent
2: Taste of freshly baked bread exists
3: Taste of freshly baked bread is slightly strong
4: Taste of freshly baked bread is strong
5: Taste of freshly baked bread is very strong

### Example 2

An evaluation was conducted in the same manner as in Example 1, except that baguette was hermetically heat-sealed two minutes after placing the baguette in a bread packaging film. In Example 2 as well, steam arising from the baguette was observable when packaging; however, the steam was less than Example 1.

### Example 3

An evaluation was conducted in the same manner as in Example 1, except that baguette was hermetically heat-sealed five minutes after placing the baguette in a bread packaging film. In Example 3 as well, steam arising from the baguette was observable when packaging; however, the steam was less than Example 2.

### Example 4

An evaluation was conducted in the same manner as in Example 1, except that pain de campagne was used instead of baguette. In Example 4 as well, steam arising from the pain de campagne was observable when packaging.

### Comparative Example 1

After manufacturing baguette by baking, the baguette was frozen at −20° C. to obtain frozen bread (frozen baguette). Steam was not observed from the frozen bread. Subsequently, the frozen bread obtained was hermetically heat-sealed and packaged using a bread packaging film to obtain a packaged frozen bread product. The same film as in Example 1 was used as a bread packaging film. Thereafter, the packaged frozen bread product was kept frozen for 90 days and then naturally thawed at room temperature. A sensory evaluation was conducted in the same manner as in Example 1, on aroma and taste of the bread when opening the packaged frozen bread product thawed.

### Comparative Example 2

An evaluation was conducted in the same manner as in Example 1, except that a nylon 6 film having a thickness of 25 pm was used as a bread packaging film (water vapor permeability of 150 g/(m²·day) as measured on conditions of 40° C. and 90% RH, based on JIS K 7129) instead of the film of Example 1.

### Comparative Example 3

An evaluation was conducted in the same manner as in Example 1, except that a packaged frozen bread product was kept frozen for 90 days, and opened and then thawed at room temperature. In Comparative Example 3, bread thawed after opening was evaluated.

TABLE 1

| | Example | Example | Example | Example | Comparative | Comparative | Comparative |
|---|---|---|---|---|---|---|---|
| | 1 | 2 | 3 | 4 | Example 1 | Example 2 | Example 3 |
| AROMA | 4.8 | 4.4 | 3.8 | 4.8 | 1.0 | 1.0 | 1.0 |
| TASTE | 4.4 | 4.0 | 3.6 | 4.4 | 1.0 | 1.0 | 1.0 |

As shown in Table 1, the packaged frozen bread products of Examples 1 to 4 were obtained by hermetically packaging bread in a bread packaging film having a gas barrier layer after baking the bread and before the temperature drops to room temperature, and then freezing the packaged bread, in which aroma and taste of freshly baked bread were experienced when opening the package after thawing the frozen bread. It should be noted that an evaluation was conducted in the same manner as described above, in which a film made of PVA, a film made of PAN, and a film made of COC were used as a bread packaging film instead of the film of Example 1; and the same results were obtained.

### Example 5

### Cake Confectionery

After manufacturing cake confectionery by baking, the cake confectionery was hermetically heat-sealed and packaged using a packaging film, in a state in which steam arising from the cake confectionery was observable. The package was filled with aroma components and water vapor arising from the cake confectionery. The cake confectionery was hermetically heat-sealed immediately after placing the cake confectionery in the packaging film. The same packaging film as in Example 1 was used. Subsequently, the packaged cake confectionery was frozen at −20° C. to obtain a packaged frozen cake confectionery product (frozen cake confectionery product). Thereafter, the packaged frozen cake confectionary product was kept frozen for 90 days and then naturally thawed at room temperature (20° C.). A sensory evaluation by the panel of five experts was conducted on aroma and taste (texture) of the cake confectionery when opening the packaged frozen cake confectionary product thawed. Aroma was evaluated on a scale of 1 to 5 as follows, in which aroma immediately after manufacturing cake confectionery by baking was 5; and aroma of cake confectionery at room temperature was 1. Taste was evaluated on a scale of 1 to 5 as follows, in which taste immediately after manufacturing cake confectionery by baking was 5; and taste of cake confectionery at room temperature was 1. Table 2 shows mean values of the evaluation by the panel of five experts.

“Aroma”
1: Aroma of freshly baked cake confectionery is absent
2: Aroma of freshly baked cake confectionery exists
3: Aroma of freshly baked cake confectionery is slightly strong
4: Aroma of freshly baked cake confectionery is strong
5: Aroma of freshly baked cake confectionery is very strong

“Taste (Texture)”
1: Taste of freshly baked cake confectionery is absent
2: Taste of freshly baked cake confectionery exists
3: Taste of freshly baked cake confectionery is slightly strong
4: Taste of freshly baked cake confectionery is strong
5: Taste of freshly baked cake confectionery is very strong

### Example 6

An evaluation was conducted in the same manner as in Example 5, except that cake confectionery was hermetically heat-sealed two minutes after placing the cake confectionery in a packaging film. In Example 6 as well, steam arising from the cake confectionery was observable when packaging; however, the steam was less than Example 5.

### Example 7

An evaluation was conducted in the same manner as in Example 5, except that cake confectionery was hermetically heat-sealed five minutes after placing the cake confectionery in a packaging film. In Example 7 as well, steam arising from the cake confectionery was observable when packaging; however, the steam was less than Example 6.

### Comparative Example 4

After manufacturing cake confectionery by baking, the cake confectionery was frozen at −20° C. to obtain frozen bread. Steam was not observed from the frozen cake confectionery. Subsequently, the frozen cake confectionery obtained was hermetically heat-sealed and packaged using the same packaging film as in Example 5 to obtain a packaged frozen cake confectionery product. Thereafter, the packaged frozen cake confectionery product was kept frozen for 90 days and then naturally thawed at room temperature. A sensory evaluation was conducted in the same manner as in Example 5, on aroma and taste of the cake confectionery when opening the packaged frozen product thawed.

### Comparative Example 5

An evaluation was conducted in the same manner as in Example 5, except that a nylon 6 film having a thickness of 25 pm was used as a packaging film (water vapor permeability of 150 g/(m²·day) as measured on conditions of 40° C. and 90% RH, based on JIS K 7129) instead of the film of Example 5.

### Comparative Example 6

An evaluation was conducted in the same manner as in Example 5, except that a packaged frozen cake confectionery product was kept frozen for 90 days, and opened and then thawed at room temperature. In Comparative Example 6, cake confectionery thawed after opening was evaluated.

TABLE 2

| | Example | Example | Example | Comparative | Comparative | Comparative |
|---|---|---|---|---|---|---|
| | 5 | 6 | 7 | Example 4 | Example 5 | Example 6 |
| AROMA | 4.6 | 4.3 | 4.0 | 1.0 | 1.0 | 1.0 |
| TASTE | 4.6 | 4.2 | 3.9 | 1.0 | 1.0 | 1.0 |

As shown in Table 2, the packaged frozen cake confectionery products of Examples 5 to 7 were obtained by hermetically packaging cake confectionery in a packaging film having a gas barrier layer after baking the cake confectionery and before the temperature drops to room temperature, and then freezing the packaged cake confectionery, in which aroma and taste of freshly baked cake confectionery were experienced when opening the package after thawing the frozen cake confectionery. It should be noted that an evaluation was conducted in the same manner as described above, in which a film made of PVA, a film made of PAN, and a film made of COC were used as a packaging film instead of the film of Example 5; and the same results were obtained.

### Example 8

### Sweet Potato Paste

Ingredients of sweet potato paste were mixed and steamed, added with dissolved agar, and placed in a rectangular box. The sweet potato paste was hermetically heat-sealed and packaged using a packaging film, in a state in which steam arising from the sweet potato paste was observable. The package was filled with water vapor arising from the sweet potato paste. The sweet potato paste was hermetically heat-sealed immediately after placing the sweet potato paste in the packaging film. The same packaging film as in Example 1 was used. Subsequently, the packaged sweet potato paste was frozen at −20° C. to obtain a packaged frozen sweet potato paste product. Thereafter, the packaged frozen sweet potato paste product was kept frozen for 90 days and then naturally thawed at room temperature (20° C.). A sensory evaluation by the panel of five experts was conducted on savor (taste or texture) of the sweet potato paste when opening the packaged frozen sweet potato paste product thawed. Aroma was evaluated on a scale of 1 to 5 as follows, in which savor immediately after molding sweet potato paste in a rectangular box was 5; and savor of sweet potato paste at room temperature was 1. Table 3 shows mean values of the evaluation by the panel of five experts.

“Savor”
1: Savor of freshly made sweet potato paste is absent
2: Savor of freshly made sweet potato paste exists
3: Savor of freshly made sweet potato paste is slightly strong
4: Savor of freshly made sweet potato paste is strong
5: Savor of freshly made sweet potato paste is very strong

### Example 9

An evaluation was conducted in the same manner as in Example 8, except that sweet potato paste was hermetically heat-sealed two minutes after placing the sweet potato paste in a packaging film. In Example 9 as well, steam arising from the sweet potato paste was observable when packaging; however, the steam was less than Example 8.

### Example 10

An evaluation was conducted in the same manner as in Example 8, except that sweet potato paste was hermetically heat-sealed five minutes after placing the sweet potato paste in a packaging film. In Example 10 as well, steam arising from the sweet potato paste was observable when packaging; however, the steam was less than Example 9.

### Comparative Example 7

Ingredients of sweet potato paste were mixed and steamed, added with dissolved agar, and placed in a rectangular box. Thereafter, the sweet potato paste was frozen at −20° C. to obtain frozen sweet potato paste. Steam was not observed from the frozen sweet potato paste. Subsequently, the frozen sweet potato paste obtained was hermetically heat-sealed and packaged using the same packaging film as in Example 8 to obtain a packaged frozen sweet potato paste product. Thereafter, the packaged frozen sweet potato paste product was kept frozen for 90 days and then naturally thawed at room temperature. A sensory evaluation was conducted in the same manner as in Example 8, on savor of the sweet potato paste when opening the packaged frozen product thawed.

### Comparative Example 8

An evaluation was conducted in the same manner as in Example 8, except that a nylon 6 film having a thickness of 25 pm was used as a packaging film (water vapor permeability of 150 g/(m²·day) as measured on conditions of 40° C. and 90% RH, based on JIS K 7129) instead of the film of Example 8.

TABLE 3

| | Example | Example | Example | Comparative | Comparative |
|---|---|---|---|---|---|
| | 8 | 9 | 10 | Example 7 | Example 8 |
| SAVOR | 4.8 | 4.5 | 4.3 | 1.0 | 1.0 |

As shown in Table 3, the packaged frozen sweet potato paste products of Examples 8 to 10 were obtained by hermetically packaging sweet potato paste in a packaging film having a gas barrier layer after steaming sweet potato paste in a rectangular box and before the temperature drops to room temperature, and then freezing the packaged sweet potato paste, in which savor of freshly made sweet potato paste was experienced when opening the package after thawing the frozen sweet potato paste. It should be noted that an evaluation was conducted in the same manner as described above, in which a film made of PVA, a film made of PAN, and a film made of COC were used as a packaging film instead of the film of Example 8; and the same results were obtained.

### Example 11

### Daifuku (Soft Rice Cake Stuffed with Adzuki Bean Paste)

Daifuku was prepared by wrapping adzuki bean paste with an outer part made of a material like rice cake made by mixing and heating (steaming) rice cake flour, sugar and water together. The daifuku was hermetically heat-sealed and packaged using a packaging film, in a state in which steam arising from the daifuku was observable. The package was filled with water vapor arising from the daifuku. The daifuku was hermetically heat-sealed immediately after placing the daifuku in the packaging film. The same packaging film as in Example 1 was used. Subsequently, the packaged daifuku was frozen at −20° C. to obtain a packaged frozen daifuku product. Thereafter, the packaged frozen daifuku product was kept frozen for 90 days and then naturally thawed at room temperature (20° C.). A sensory evaluation by the panel of five experts was conducted on savor (taste or texture) of the daifuku when opening the packaged frozen daifuku product thawed. Aroma was evaluated on a scale of 1 to 5 as follows, in which savor immediately after preparing daifuku was 5; and savor of daifuku at room temperature was 1. Table 4 shows mean values of the evaluation by the panel of five experts.

“Savor”
1: Savor of freshly made daifuku is absent
2: Savor of freshly made daifuku exists
3: Savor of freshly made daifuku is slightly strong
4: Savor of freshly made daifuku is strong
5: Savor of freshly made daifuku is very strong

### Example 12

An evaluation was conducted in the same manner as in Example 11, except that daifuku was hermetically heat-sealed two minutes after placing the daifuku in a packaging film. In Example 12 as well, steam arising from the daifuku was observable when packaging; however, the steam was less than Example 11.

### Example 13

An evaluation was conducted in the same manner as in Example 11, except that daifuku was hermetically heat-sealed five minutes after placing the daifuku in a packaging film. In Example 13 as well, steam arising from the daifuku was observable when packaging; however, the steam was less than Example 12.

### Comparative Example 9

The daifuku was frozen at −20° C. to obtain frozen daifuku. Steam was not observed from the frozen daifuku. Subsequently, the frozen daifuku obtained was hermetically heat-sealed and packaged using the same packaging film as in Example 11 to obtain a packaged frozen daifuku product. Thereafter, the packaged frozen daifuku product was kept frozen for 90 days and then naturally thawed at room temperature. A sensory evaluation was conducted in the same manner as in Example 11, on savor of the daifuku when opening the packaged frozen product thawed.

### Comparative Example 10

An evaluation was conducted in the same manner as in Example 11, except that a nylon 6 film having a thickness of 25 μm was used as a packaging film (water vapor permeability of 150 g/(m²·day) as measured on conditions of 40° C. and 90% RH, based on JIS K 7129) instead of the film of Example 11.

TABLE 4

| | Example | Example | Example | Comparative | Comparative |
|---|---|---|---|---|---|
| | 11 | 12 | 13 | Example 9 | Example 10 |
| SAVOR | 4.6 | 4.4 | 4.3 | 1.0 | 1.0 |

As shown in Table 4, the packaged frozen daifuku products of Examples 11 to 13 were obtained by hermetically packaging daifuku in a packaging film having a gas barrier layer before the temperature drops to room temperature, and then freezing the packaged daifuku, in which savor of freshly made daifuku was experienced when opening the package after thawing the frozen daifuku. It should be noted that an evaluation was conducted in the same manner as described above, in which a film made of PVA, a film made of PAN, and a film made of COC were used as a packaging film instead of the film of Example 11; and the same results were obtained.

1. A method of manufacturing a packaged frozen food product, the method comprising:
a packaging step of hermetically packaging food in a film including a gas barrier layer after baking or steaming the food and before temperature of the food drops to room temperature, the food being unbaked confectionery, semi-baked confectionery, bread, or rice cake; and
a freezing step of freezing the food packaged in the packaging step, and obtaining frozen food.

2. The method of manufacturing a packaged frozen food product according to claim 1, wherein the method does not comprise a step of replacing gas in the film after the packaging step.

3. The method of manufacturing a packaged frozen food product according to claim 1, wherein the food is hermetically packaged within two minutes after placing the food in the film in the packaging step.

4. The method of manufacturing a packaged frozen food product according to claim 1, wherein the food is hermetically packaged in a state in which steam released from the food is visually recognizable in the packaging step.

5. (canceled)

6. The method of manufacturing a packaged frozen food product according to claim 1, wherein water vapor permeability of the film including a gas barrier layer is 20 g/(m²·day) or less, as measured under conditions of 40° C. and 90% RH, based on JIS K 7129.

7. The method of manufacturing a packaged frozen food product according to claim 1, wherein the gas barrier layer has desired low permeability to aroma components selected from a group consisting of acetaldehyde, hexanal, 2-heptene, 2-nonanone, nonanal, and ethyl octanoate.

8. The method of manufacturing a packaged frozen food product according to claim 1, wherein the gas barrier layer includes one or more selected from a group consisting of ethylene vinyl alcohol copolymer resin (EvOH), polyvinyl alcohol (PVA), polyacrylonitrile (PAN), and cyclic olefin copolymer (COC).

9. The method of manufacturing a packaged frozen food product according to claim 1, the film including a gas barrier layer further comprising:
a guiding portion that is provided at an outer edge of the film and guides a start of cutting; and
a defining portion that is provided on the film and is spaced apart from the guiding portion, the defining portion defining an end position of the cutting.

10. A packaged frozen food product, comprising:
the food packaging film including a gas barrier layer; and
frozen food that is food hermetically packaged in the food packaging film after baking or steaming the food and before temperature of the food drops to room temperature, the food being subsequently frozen, wherein
the packaged frozen food product is used by opening the food packaging film after thawing the frozen food.
